(19) United States
(12) Patent Application Publication
(10) Pub. No.: US 2011/0006247 A1
(43) Pub. Date: Jan. 13, 2011

(54) HYDROPHOBIZED SILICON-IRON MIXED OXIDE

(75) Inventors: Stipan Katusic, Bad Soden (DE); Juergen Meyer, Stockstadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GMBH, Essen (DE)

(21) Appl. No.: 12/922,813

(22) PCT Filed: Mar. 30, 2009
(86) PCT No.: PCT/EP2009/053734

§ 371 Date: Sep. 15, 2010

(30) Foreign Application Priority Data
Apr. 28, 2008 (DE) 102008001433.8

(51) Int. Cl. H01F 1/01

(52) U.S. Cl. 252/62.59

(57) ABSTRACT

Hydrophobized silicon-iron mixed oxide powder, characterized in that it has the following physicochemical characteristics: BET surface area 20 to 75 mVg; Carbon content 0.5 to 10% by weight; Tamped density 150 to 600 g/l; Chlorine content 0.1 to 3.0%; Drying loss 0.1 to 4% by weight; DVS isotherm (60%) 0.5 to 1.5% by weight; Heating rate (Is, 10%) 50 to 550° C./s; 90% range (number) 5 to 50 nm; 90% range (weight) 5 to 150 nm; Overall range 2 to 200 nm, is prepared by treating a silicon-iron mixed oxide powder with the surface modifier either in spray form or in vapour form, and then heat treating it. The surface-modified oxidic particles can be used as a filler in adhesives. Further fields of use are use for data carriers, as a contrast agent in imaging processes, for biochemical separation and analysis processes, for medical applications, as an abrasive, as a catalyst or as a catalyst support, as a thickener, for thermal insulation, as a dispersing aid, as a flow aid and in ferrofluids.

The invention relates to a hydrophobized silicon-iron mixed oxide powder, to a process for preparation thereof and to the use thereof.

EP-A 1 284 485 discloses a process in which chloride-containing starting materials can be used and the resulting silicon-iron mixed oxide particles, in spite of a chloride content of up to 1000 ppm, still have good magnetic properties. The particles disclosed in EP-A 1 284 485 include superparamagnetic iron oxide domains with a diameter of 3 to 20 nm in a silicon dioxide-containing matrix. Compared to the purely organic processes, the process disclosed in EP-A 1 284 485 offers economic advantages. However, there is still the desire for particles which can be produced less expensively.

It was therefore an object of the present invention to provide particles with good magnetic properties, which are producible by means of an economically viable process.

Silicon-iron mixed oxide powders are known from EP 071097863.8 (internal reference 2007P00380EP).

The invention provides hydrophobized silicon-iron mixed oxide powders, which are characterized in that they have the following physicochemical characteristics:

| | |
|---|---|
| BET surface area | 20 to 75 m²/g |
| Carbon content | 0.5 to 10% by weight |
| Tamped density | 150 to 600 g/l |
| Chlorine content | 0.1 to 3.0% |
| Drying loss | 0.1 to 4% by weight |
| DVS isotherm (60%) | 0.5 to 1.5% by weight |
| Heating rate (1s, 10%) | 50 to 550° C./s |
| 90% range (number) | 5 to 50 nm |
| 90% range (weight) | 5 to 150 nm |
| Overall range | 2 to 200 nm. |

The invention further provides a process for preparing the inventive hydrophobized silicon-iron mixed oxide powder, which is characterized in that a silicon-iron mixed oxide powder is optionally sprayed first with water and then with a surface modifier at room temperature, optionally mixed for a further 15 to 30 minutes and then heat treated at 50 to 400° C. over 1 to 6 hours.

The water used can be acidified with an acid, for example with hydrochloric acid, down to a pH of 7 to 1.

Alternatively, the hydrophobization of the silicon-iron mixed oxide can be carried out by treating the silicon-iron mixed oxide with a surface modifier in vapour form and then treating the mixture thermally at a temperature of 50 to 800° C. over a period of 0.5 to 6 h.

The thermal treatment can be effected under protective gas, for example nitrogen.

The hydrophobization can be carried out continuously or batchwise in heatable mixers and dryers with spray equipment.

Suitable apparatus may, for example, be: ploughshare mixers, plate dryers or fluidized bed dryers.

The reactant used for the inventive hydrophobized silicon-iron mixed oxide is a silicon-iron mixed oxide powder with magnetic properties in the form of aggregated primary particles. It is known from EP 071097863.8. In the case of these reactants, TEM images show the presence of primary particles composed of spatially separate regions of silicon dioxide and iron oxide. The mean particle diameter of the iron oxide is 2 to 100 nm.

The proportion of
silicon, calculated as SiO₂, is 5 to 65% by weight
iron, calculated as Fe₂O₃, is 30 to 90% by weight
and the proportion of silicon and iron, each calculated as abovementioned oxides, is at least 95% by weight
the proportion of chloride is 0.2 to 3% by weight.

Magnetic properties are understood to mean ferrimagnetic, ferromagnetic and/or superparamagnetic properties. The silicon-iron mixed oxide used in accordance with the invention may preferably be a powder with superparamagnetic properties.

Superparamagnetic substances do not have permanent (coincident) arrangement of the elementary magnetic dipoles in the absence of external, active magnetic fields. They may have a low residual magnetization.

The silicon-iron mixed oxide used in accordance with the invention may preferably be a powder whose proportion of silicon is 50±10% by weight or 20±10% by weight.

The silicon-iron mixed oxide used in accordance with the invention may further preferably be a powder whose proportion of iron is 50±10% by weight or 80±10% by weight.

The primary particles include those in which the mixed oxide components are present both in and on the surface of a primary particle.

In the contact region of silicon dioxide and iron oxide within a primary particle, Si—O—Fe may be present.

Furthermore, individual primary particles even composed only of silicon dioxide and/or iron oxide may be present.

The primary particles are very substantially pore-free, but have free hydroxyl groups on the surface and may have different degrees of aggregation.

The aggregates are three-dimensional aggregates. In general, the aggregate diameter, in one three-dimensional direction in each case, is preferably not more than 250 nm, generally from 30 to 200 nm.

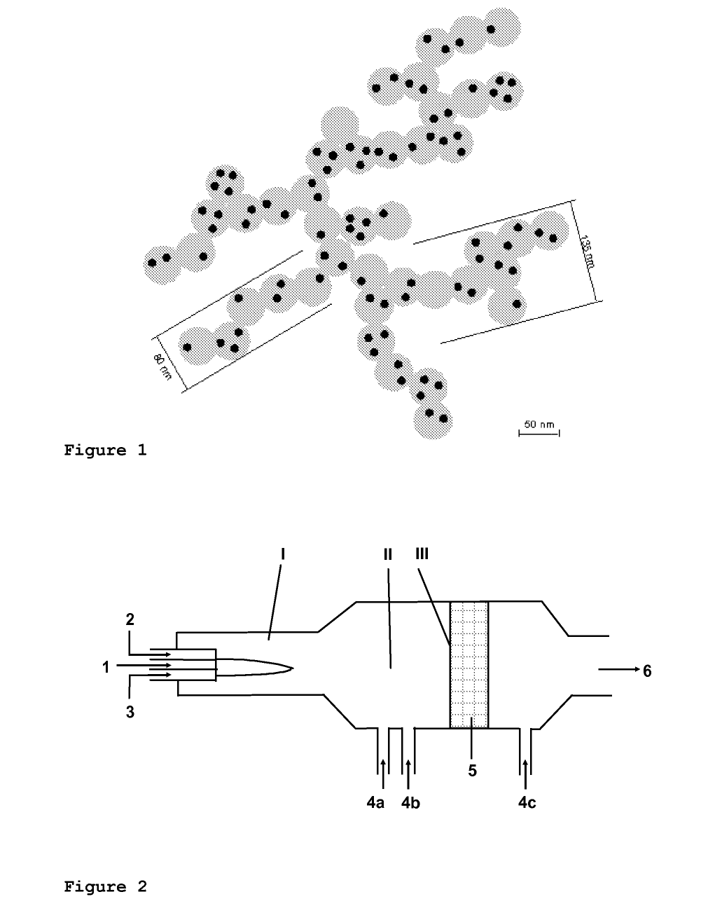

FIG. 1 shows a schematic of such a three-dimensional structure with an aggregate diameter of 135 nm and 80 nm. Several aggregates may combine to form agglomerates. These agglomerates can be separated again easily. In contrast, the division of the aggregates into the primary particles is generally impossible.

The silicon-iron mixed oxide powder used in accordance with the invention is notable in particular for a high chloride content of 0.2 to 3% by weight, based on the silicon-iron mixed oxide particles. The chloride content originates from the preparation of the particles, like the silicon-iron mixed oxide powders used in accordance with the invention, are obtained by a pyrogenic process in which chlorine-containing precursors are used. The particles which form contain chlorine generally in the form of hydrochloric acid. This can adhere or be incorporated within the particles which form.

It has, however, been found that chloride contents of 0.2 to 3% by weight have only a negligible influence, if any, on the magnetic properties of the powder.

Preference may be given to a silicon-iron mixed oxide powder having a chloride content of 0.5 to 2.5% by weight; in particular, a silicon-iron mixed oxide powder having a chloride content of from 1 to 2% by weight can be used.

The total chloride content is determined by Wickbold combustion or by digestion with subsequent titration or ion chromatography.

Moreover, TEM images of the inventive powder show the presence of primary particles composed of spatially separate regions of silicon dioxide and iron oxide. Silicon dioxide may form an envelope around the iron oxide with a thickness of 1 to 15 nm.

The mean diameter of the iron oxide constituents may be 2 to 100 nm, preferably less than 70 nm, especially >20 to 60 nm.

The silicon-iron mixed oxide powder used in accordance with the invention may further comprise at least one or more primary particles which consist of silicon dioxide or iron oxide, i.e. in which silicon dioxide and iron oxide are not present together.

The proportions of primary particles which have only silicon dioxide or iron oxide may be obtained by counting from TEM images; in general, several thousand primary particles are evaluated. The proportions are 0 to a maximum of 5%, generally 0 to <1%, of the counted primary particles.

The silicon dioxide constituent in the silicon-iron mixed oxide powder used in accordance with the invention may be present in either crystalline or amorphous form, preference being given to purely amorphous silicon dioxide.

The iron oxide constituent of the particles of the silicon-iron mixed oxide powder used in accordance with the invention may preferably have magnetite and/or maghemite as the main constituent. In addition, it may comprise a total of up to 15%, generally less than 10%, based on the iron oxides, of haematite, beta-Fe2O3 and iron silicate.

More preferably, the silicon-iron mixed oxide powder used in accordance with the invention may have a proportion of magnetite and/or maghemite, based on the iron oxides, of at least 80%, most preferably at least 90%.

When the intention is to vary the magnetic properties of the silicon-iron mixed oxide powder used in accordance with the invention, it may also be advantageous to provide a silicon-iron mixed oxide powder used in accordance with the invention in which the maghemite/magnetite weight ratio is 0.3:1 to 100:1. It is likewise possible that the iron oxide is present only in the form of maghemite.

The proportion of iron oxide, calculated as Fe₂O₃, in the silicon-iron mixed oxide powder used in accordance with the invention is 30 to 90% by weight. The silicon-iron mixed oxide powder used in accordance with the invention may preferably have a proportion of iron oxide of 50±10% by weight or 80±10% by weight. Particular preference is given to a range of 50±5% by weight or 80±5% by weight.

The sum of silicon dioxide and iron oxide in the silicon-iron mixed oxide powder used in accordance with the invention may be at least 95% by weight, preferably at least 98% by weight and more preferably at least 98.5% by weight.

In addition to silicon dioxide, iron oxide and chloride, the inventive mixed oxide powder may comprise at least one doping component. This is preferably selected from the group consisting of the oxides of manganese, cobalt, chromium, europium, yttrium, samarium, nickel and gadolinium.

A particularly preferred doping component is manganese oxide.

The proportion of the doping component may preferably be 0.005 to 2% by weight, more preferably 0.5 to 1.8% by weight and most preferably 0.8 to 1.5% by weight, calculated in each case as the oxide and based on the mixed oxide powder.

The doping component may generally be distributed homogeneously in the powder. Depending on the type of dopant and the reaction, the doping component may be present in enriched form in regions of silicon dioxide or iron oxide.

The BET surface area of the inventive mixed oxide powder can be varied within wide ranges. A favourable BET surface area has been found to be in the range of 10 to 100 m²/g. Preference may be given to mixed oxide powders having a BET surface area of 40 to 70 m²/g.

The particles of the silicon-iron mixed oxide powder used in accordance with the invention may be enveloped by one or more shells of identical or different polymers or polymer mixtures. Particularly suitable polymers may be polymethyl methacrylates.

The silicon-iron mixed oxide powder used in accordance with the invention features a high saturation magnetization. The silicon-iron mixed oxide powders used in accordance with the invention may preferably have a saturation magnetization of 40 to 120 Am²/kg Fe₂O₃ and more preferably 60 to 100 Am²/kg Fe₂O₃.

It has also been found that an advantageous silicon-iron mixed oxide powder used in accordance with the invention is one which has the following features:
a) BET surface area 50±5 m²/g
b) proportion of
   silicon, calculated as SiO₂, 50±5% by weight
   iron, calculated as Fe₂O₃, 45±5% by weight
   chloride 1.5±0.5% by weight
   manganese, calculated as MnO, 0.5±0.3% by weight,
   where the sum of the oxides adds up to 100%,
c) mean diameter of the iron oxide 10-30 nm
d) proportion of (magnetite+maghemite), based on iron oxide, 90±10% by weight.

It has also been found that an advantageous silicon-iron mixed oxide powder used in accordance with the invention is one which has the following features:
a) BET surface area 50±10 m²/g
b) proportion of
   silicon, calculated as SiO₂, 10±5% by weight
   iron, calculated as Fe₂O₃, 85±5% by weight
   chloride 1.0±0.2% by weight
   manganese, calculated as MnO, 1.8±0.2% by weight,
c) mean diameter of the iron oxide 10-30 nm
d) proportion of (magnetite+maghemite), based on iron oxide, 90±10% by weight.

The silicon-iron mixed oxide powder used in accordance with the invention can be prepared by feeding
a) 10 to 60% by weight of one or more vaporous halosilicon compounds, calculated as SiO₂,
b) 40 to 90% by weight of iron chloride, calculated as Fe₂O₃, in the form of a solution and
c) optionally 0.005 to 2% by weight of one or more doping compounds, calculated as oxide,
d) separately to the high-temperature zone of a reactor,
e) reacting them in the high-temperature zone at temperatures of 700 to 2500° C. with an excess of oxygen or an oxygenous gas,
f) and, in a second zone of the reactor downstream of the high-temperature zone, adding reducing gases to the reaction mixture at one or more points in an amount such as to give rise to a reducing atmosphere overall in this second zone, and reducing the temperature to 500° C. to 150° C.,
g) separating the resulting solid from gaseous substances in a further, third zone in which a reducing atmosphere is likewise still present, and
h) optionally, adding sufficient air to the gaseous substances that the offgas does not give rise to a reducing atmosphere.

A solution is understood to mean one in which the main constituent of the liquid phase is water, water and one or more organic solvents, or a mixture of water with one or more organic solvents. The preferred organic solvents used may be alcohols such as methanol, ethanol, n-propanol, isopropanol, n-butanol or isobutanol or tert-butanol. Particular preference is given to those solutions in which water is the main constituent.

A doping component is understood to mean the oxide of an element which is present in the silicon-iron mixed oxide powder used in accordance with the invention.

A dopant is understood to mean the compound which is used in the process in order to obtain the doping component. The dopant may be added separately from the halosilicon compound and the iron chloride. This can be done in the form of a vapour or of a solution. The dopant may also be introduced in the form of a vapour together with the halosilicon compound or as a constituent of the iron chloride-containing solution.

The temperature can result from a flame which is generated by igniting a mixture which comprises one or more combustion gases and an oxygen-containing gas and which burns into the reaction chamber.

Suitable combustion gases may be hydrogen, methane, ethane, propane, natural gas, acetylene, carbon monoxide or mixtures of the aforementioned gases. Hydrogen is the most suitable. The oxygen-containing gas used is generally air.

As well as the mixed oxides, the reaction mixture also comprises the gaseous reaction products and any unreacted gaseous feedstocks. Gaseous reaction products may, for example, be hydrogen chloride and carbon dioxide.

The reaction mixture is mixed with a reducing gas or a mixture of a reducing gas with air which is added in zone II of the reactor. The reducing gas may, for example, be forming gas, hydrogen, carbon monoxide, ammonia or mixtures of the aforementioned gases, and particular preference may be given to forming gas. Such a reducing gas is added to the reaction mixture in such an amount as to give rise to a reducing atmosphere.

A reducing atmosphere is understood to mean one in which the lambda value is less than 1.

Lambda is calculated from the quotient of the sum of the oxygen content of the oxygenous gas divided by the sum of the iron and silicon compounds to be oxidized and/or to be hydrolysed and of the hydrogen-containing combustion gas, in each case in mol/h.

When, for example, hydrogen and air are used in the high-temperature zone (zone I) and air and forming gas (80:20 N₂/H₂) are used in zone II, the lambda value is calculated according to the following formula in zone II and III to be 0.21·excess air from zone I/0.5·(H₂+0.2·forming gas), based in each case on the amount of gas introduced per unit time.

For zone I, the lambda value is greater than 1. When hydrogen and air are used, the lambda value in zone I is determined according to the following formula: 0.21·air/0.5·H₂.

The residence time in the first zone may be between 0.8 and 1.5 seconds.

The sum of the residence times in the second and third zone may be between 15 seconds and 15 minutes.

It is additionally possible for steam to be introduced into the second reactor zone.

FIG. 2 shows, by way of example, a schematic setup for the performance of the process. I, II and III denote the three reaction zones. In addition:
1=atomized solution of iron chloride which optionally comprises additional dopants;
2=oxygen-containing gas, preferably air;
3=combustion gas, preferably hydrogen;
4a =reducing gas; 4b=steam (optional); 4c=air (optional)
5=inventive powder deposited on filters;
6=offgas.

The iron chloride used may preferably be iron(II) chloride (FeCl₂), iron(III) chloride (FeCl₃) or a mixture of the two. The iron chloride is introduced as a solution. The concentration of the iron chloride may preferably be 1 to 30% by weight and more preferably 10 to 20% by weight, based in each case on the solution.

The halosilicon compounds used with preference may be SiCl₄, CH₃SiCl₃, (CH₃)₂SiCl₂, (CH₃)₃SiCl, (CH₃)₄Si, HSiCl₃, (CH₃)₂HSiCl, CH₂C₂H₅SiCl₂, disilanes of the general formula RₙCl₃₋ₙSiSiRₘCl₃₋ₙ where R═CH₃ and n+m=2,3,4,5 and 6, and also mixtures of the aforementioned compounds. Particular preference is given to the use of silicon tetrachloride.

It is also possible to use halosilicon compounds from those fractional cuts obtained in the Müller-Rochow synthesis, and the fractional cuts may also comprise proportions of C₁-C₁₂-hydrocarbons. The proportion of these hydrocarbons may be up to 10% by weight, based on one fraction. Usually, these proportions are between 0.01 and 5% by weight, and the proportion of the C₆ hydrocarbons, for example cis- and trans-2-hexene, cis- and trans-3-methyl-2-pentene, 2,3-dimethyl-2-butene, 2-methylpentane, 3-methylpentane generally predominates. When halosilicon compounds from the Müller-Rochow synthesis are used, this is preferably done in mixtures with silicon tetrachloride.

The silicon-iron mixed oxide powder used in accordance with the invention can also be prepared by feeding
a) 10 to 60% by weight of one or more vaporous halosilicon compounds, calculated as SiO₂,
b) 40 to 90% by weight of iron chloride, calculated as Fe₂O₃, in the form of a solution and
c) optionally 0.005 to 2% by weight of one or more doping compounds, calculated as oxide,
d) separately to the high-temperature zone of a reactor,
e) reacting them in the high-temperature zone at temperatures of 700 to 2500° C. in a flame which is generated by the ignition of a mixture which comprises one or more combustion gases and an oxygen-containing gas and which burns into the reaction chamber, and in which oxygen is used in deficiency,
f) in a second zone of the reactor downstream of the high-temperature zone, adding air or air and steam to the reaction mixture at one or more points in an amount such as to give rise to, overall in this second zone, a
   reducing atmosphere or
   oxidizing atmosphere and
   reducing the temperature to 500° C. to 150° C. and
g) removing the resulting solid, in a further, third zone, from gaseous substances of the same atmosphere as is present in the second zone, and
h) optionally, adding sufficient air to the gaseous substances that the offgas does not give rise to a reducing atmosphere.

A reducing atmosphere is understood to mean one in which the lambda value in zone I, II and III is less than 1.

An oxidizing atmosphere is understood to mean one in which the lambda value in zone II and III is greater than 1.

With regard to the type of compounds used and the reaction parameters, the statements made for the process already specified apply.

FIG. 2 shows, by way of example, a schematic setup for performing this process. I, II and III denote the three reaction zones. In addition:
1=atomized solution of iron chloride which optionally comprises additional dopants;
2=oxygen-containing gas, preferably air;
3=combustion gas, preferably hydrogen (excess);
4a=air (excess or deficiency); 4b=steam (optional); 4c=air (optional);
5=silicon-iron mixed oxide powder deposited on filters;
6=offgas.

The particles usable in accordance with the invention may, depending on the configuration of the pyrogenic process, have different degrees of aggregation. Influencing parameters may be residence time, temperature, pressure, the partial pressures of the compounds used, the type and location of cooling after the reaction. Thus, a wide spectrum of very substantially spherical to very substantially aggregated particles can be obtained.

The domains of the particles usable in accordance with the invention are understood to mean spatially separated superparamagnetic regions. As a result of the pyrogenic process, the particles usable in accordance with the invention are very substantially pore-free and have free hydroxyl groups on the surface. They have superparamagnetic properties when an external magnetic field is applied. However, they are not permanently magnetized and have only a low residual magnetization.

In a particular embodiment, the carbon content of the particles usable in accordance with the invention may be less than 500 ppm. The range may more preferably be less than 100 ppm.

The BET surface area, determined to DIN 66131, of the inventive particles can be varied over a wide range of 10 to 600 m²/g. The range is particularly advantageously between 50 and 300 m²/g.

The tamped density, determined to DIN ISO 787/11, of the inventive particles can be varied over a wide range of 150 to 500 g/l. The range is particularly advantageously between 200 and 350 g/l.

The drying loss (2 hours at 105° C.), determined to DIN ISO 787/2, of the inventive particles can be varied over a wide range of 0.1 to 4.0% by weight. The range is particularly advantageously between 0.5 and 2.0% by weight.

The heating rates are determined by two different methods with the following equipment. Instrument: Celes GCTM25, plate inductor N=3, Da=48, Di=8, Cu 6×1, approx. 655 kHz.

Method A: 1s, 10% power, powder bulk density

Method B: 6s, 5% power, powder bulk density

The DVS isotherm, determined by method AN-SOP 1326 of Aqura GmbH, of the inventive particles may vary over a wide range of 0.04 to 1.65, depending on the relative air humidity.

In a preferred embodiment, the “blocking temperature”, the temperature below which no superparamagnetic behaviour can be detected any longer, of the particles usable in accordance with the invention cannot be more than 150 K. As well as the composition of the particle, this temperature may also depend on the size of the superparamagnetic domains and the anisotropy thereof.

The proportion of the superparamagnetic domains of the particles usable in accordance with the invention may be between 1 and 99.6% by weight. Within this range, as a result of the nonmagnetic matrix, spatially separated regions of superparamagnetic domains are present. The region with a proportion of superparamagnetic domains is preferably greater than 30% by weight, more preferably greater than 50% by weight. The achievable magnetic action of the particles usable in accordance with the invention also increases with the proportion of the superparamagnetic regions.

The superparamagnetic domains may preferably comprise the oxides of Fe, Cr, Eu, Y, Sm or Gd. In these domains, the metal oxides may be present in a homogeneous polymorph or in different polymorphs.

In addition, it is also possible for regions of nonmagnetic polymorphs to be present in the particles. These may be mixed oxides of the nonmagnetic matrix with the domains. One example thereof is iron silicalite (FeSiO₄). These nonmagnetic constituents behave towards the superparamagnetism like the nonmagnetic matrix. In other words: The particles are superparamagnetic, but the saturation magnetization falls with increasing proportion of the nonmagnetic constituents.

In addition, it is also possible for magnetic domains to be present, which, owing to their size, do not exhibit superparamagnetism and induce remnant magnetization. This leads to an increase in the volume-specific saturation magnetization. According to the field of use, it is possible to produce particles adapted in this way.

A particularly preferred superparamagnetic domain is iron oxide in the form of gamma-Fe₂O₃ (γ-Fe₂O₃), Fe₃O₄, mixtures of gamma-Fe₂O₃ (γ-Fe₂O₃) and Fe₃O₄ and/or mixtures of the above with iron-containing, nonmagnetic compounds.

The nonmagnetic matrix may comprise the oxides of the metals and metalloids of Si, Al, Ti, Ce, Mg, Zn, B, Zr or Ge. Particular preference is given to silicon dioxide, aluminium oxide, titanium dioxide and cerium oxide. In addition to the spatial separation of the superparamagnetic domains, the matrix also has the task of stabilizing the oxidation state of the domains. For example, magnetite as the superparamagnetic iron oxide phase is stabilized by a silicon dioxide matrix.

The particles usable in accordance with the invention can be modified by adsorption, reactions at the surface or complexation of or with inorganic and organic reagents.

The particles usable in accordance with the invention may also be coated partially or completely with a further metal oxide. This can be done, for example, by dispersing the particles usable in accordance with the invention in a solution comprising organometallic compounds. After the addition of a hydrolysis catalyst, the organometallic compound is converted to its oxide, which is deposited on the particles usable in accordance with the invention. Examples of such organometallic compounds are the alkoxides of silicon (Si(OR)₄), of aluminium (Al(OR)₃) or of titanium (Ti(OR)₄).

The surface of the particles usable in accordance with the invention can also be modified by adsorption of bioorganic materials, such as nucleic acids or polysaccharides. The modification can be effected in a dispersion comprising the bioorganic material and the particles usable in accordance with the invention.

The invention further provides a process for preparing the particles usable in accordance with the invention, which is characterized in that a compound comprising the metal component of the superparamagnetic domains, and a compound comprising the metal or metalloid component of the nonmagnetic matrix, at least one compound being chlorine-containing, are evaporated, the amounts of vapour corresponding to the ultimately desired ratio of the superparamagnetic domains and nonmagnetic matrix together with a carrier gas are mixed in a mixing unit with air and/or oxygen and combustion gas, the mixture is fed to a burner of known design and reacted in a flame within a combustion chamber, then the hot gases and the solids are removed, then the gases are removed from the solids and the product is optionally purified by a thermal treatment by means of gases moistened with steam.

The combustion gases used may preferably be hydrogen or methane.

The particles usable in accordance with the invention may also be obtained by a process in which an aerosol is fed into a gas mixture of a flame hydrolysis or flame oxidation, comprising the precursor of the nonmagnetic matrix, the aerosol is mixed homogeneously with the gas mixture, the aerosol-gas mixture is fed to a burner of known design and reacted in a flame within a combustion chamber, then the hot gases and the solids are cooled, then the gases are removed from the solids and the product is optionally purified by a thermal treatment by means of gases moistened with steam, the aerosol comprising the metal component of the superparamagnetic metal oxide and being prepared by nebulization, and chloride-containing compounds being used as the precursor of the matrix and/or as the aerosol.

The nebulization can preferably be effected by means of a one- or two-substance nozzle or by means of an aerosol generator.

The reactants, precursors of the metal oxide or metalloid oxide matrix and of the superparamagnetic domains, may, in both processes usable in accordance with the invention, for example, both be inorganic chlorine-containing salts. It is also possible for only the precursor of the metal oxide or metalloid oxide matrix to be chlorine-containing, and for the precursor of the superparamagnetic domains to be a chlorine-free inorganic salt, for example a nitrate, or a chlorine-free organometallic compound, for example iron pentacarbonyl. It is also possible that the precursor of the metal oxide or metalloid oxide matrix is a chlorine-free inorganic salt, for example nitrate, or a chlorine-free organometallic compound, for example a siloxane, and the precursor of the superparamagnetic domains is a chlorine-containing inorganic salt. It is particularly preferred that both the precursor of the metal oxide or metalloid oxide matrix and the precursor of the superparamagnetic domains are chlorine-containing inorganic salts.

In both processes, the cooling can preferably be effected by means of a heat exchanger or by directly mixing in water or a gas, for example air or nitrogen, or by adiabatic decompression of the process gas through a Laval nozzle.

The hydrophobizing agents used may be the following substances:

octyltrimethoxysilane, octyltriethoxysilane, hexamethyldisilazan, 3-methacryloyloxypropyltrimethoxysilane, 3-methacryloyloxypropyltriethoxysilane, dimethylpolysiloxane, glycidyloxypropyltrimethoxysilane, glycidyloxypropyltriethoxysilane, nonafluorohexyltrimethoxysilane, tridecafluorooctyltrimethoxysilane, tridecafluorooctyltriethoxysilane, aminopropyltriethoxysilane.

More preferably, octyltrimethoxysilane, octyltriethoxysilane and dimethylpolysiloxanes can be used.

The inventive hydrophobized silicon-iron mixed oxide powders can be used as fillers in adhesives. Further fields of use are use for data carriers, as a contrast agent in imaging processes, for biochemical separation and analysis processes, for medical applications, as an abrasive, as a catalyst or as a catalyst support, as a thickener, for thermal insulation, as a dispersing aid, as a flow aid and in ferrofluids.

### EXAMPLES

Analytical Processes

Determination of the BET surface area: The BET surface area of the silicon-iron mixed oxide powder used in accordance with the invention was determined to DIN 66131.

Determination of the Content of Silicon Dioxide and Iron Oxide:

Approx. 0.3 g of the silicon-iron mixed oxide powder used in accordance with the invention is weighed accurately into a platinum crucible and, to determine the ignition loss, calcined at 700° C. for 2 h in a crucible, cooled in a desiccator and reweighed. After the edges have been rinsed with ultrapure water, the sample material is fumed to dryness on a hotplate with 1 ml of H₂SO₄ p.a. 1:1 and at least 3 ml of HF 40% p.a. The weight loss as a result of the fuming is assumed to be SiO₂ and the remainder to be Fe₂O₃.

Determination of the chloride content: Approx. 0.3 g of the silicon-iron mixed oxide powder used in accordance with the invention are weighed accurately, admixed with 20 ml of 20 per cent sodium hydroxide solution p.a., dissolved and transferred into 15 ml of cooled HNO₃ with stirring. The chloride content in the solution is titrated with AgNO₃ solution (0.1 mol/l or 0.01 mol/l).

Determination of the adiabatic combustion temperature: It is calculated from the mass and energy balance of the streams entering the reactor. The energy balance takes account both of the reaction enthalpy of the hydrogen combustion and the conversion of the silicon tetrachloride to silicon dioxide and of the iron(II) chloride to iron(II) oxide, and the evaporation of the aqueous solution.

Determination of the residence time: It is calculated from the quotient of the plant volume flowed through and the operating volume flow rate of the process gases at adiabatic combustion temperature.

Determination of the Curie temperature: The Curie temperature is determined by means of thermogravimetry (TG). This determination method is based on the behaviour of magnetic substances of losing their magnetizability at a characteristic temperature, the Curie temperature. At this temperature, the alignment of the elementary magnets is prevented owing to increasing thermal motion. When the TG curve of a ferromagnetic curve is measured in an inhomogeneous magnetic field, the magnetic force disappears at the Curie temperature. The inhomogeneous magnetic field is generated by applying two magnets laterally above the oven body. The sudden change in force at the Curie point brings about the end of the apparent weight increase. The Curie temperature corresponds to the extrapolated end of the TG stage. To illustrate the pure magnetic behaviour, the inventive powder is heated up to 1000° C. 1. in a magnetic field, 2. without a magnetic field, and measurement 2 is subtracted from measurement 1. This difference curve shows the pure magnetic behaviour. At the start of heating, the TG curve shows an increase in the magnetic force, which corresponds to an apparent decrease in the weight. From a particular temperature, the decrease in the magnetic force sets in, which leads to an apparent weight increase. This weight increase ends at the Curie temperature.

X-Ray Diffractograms (XRD)

Analysis:

Reflection, θ/θ diffractometer, Co—Kα, U=40 kV, I=35 mA Linear PSD with Fe filter, sample rotation

Slits: 2×8 mm, 0.8 mm

Angle range (2theta): 15-112.5°

Step width: 0.2°

Evaluation: Rietveld program SiroQuant®.

Magnetization: The saturation magnetization is the maximum achievable magnetic moment per unit volume. The saturation magnetization is attained in infinitely large magnetic fields. The magnetization which is established at an external field of B=5 T corresponds approximately to the saturation magnetization and is employed as a measure of the magnetizability. The saturation magnetization of the silicon-iron mixed oxide powder used in accordance with the invention from Examples 1 to 9 is significantly higher than that of Comparative Examples 1 to 3.

High-Resolution Transmission Electron Microscopy

(HR-TEM): For the manganese-containing silicon-iron mixed oxide powder used in accordance with the invention from Examples 5-7, the lattice spacings were determined by means of HR-TEM images. The powders exhibit lattice spacings of 0.25 nm, 0.26 nm and 0.27 nm. These values agree very well with the reference values for maghemite 0.25 nm, magnetite 0.252 nm and haematite 0.269 nm. Values which would suggest the presence of a manganese oxide are not found. It can also be concluded from this that manganese is incorporated into the lattice of the iron oxide.

The silicon-iron mixed oxide powder used in accordance with the invention features excellent magnetic properties. Contrary to the adverse influences, described in the literature, of chloride on the magnetic properties, the present invention shows that up to 3% by weight of chloride in the powder has no effect on the magnetic properties.

### Example 1

0.87 kg/h of SiCl₄ is evaporated and fed into a mixing zone with 7.0 m³ (STP)/h of hydrogen and 18.00 m³ (STP)/h of air.

In addition, an aerosol which is obtained from a 25 per cent by weight solution of iron(II) chloride, corresponding to 4.60 kg/h of iron(II) chloride, in water by means of a two-substance nozzle is introduced into the mixing zone within the burner by means of a carrier gas (3 m³ (STP)/h of nitrogen). The homogeneously mixed gas-aerosol mixture burns in zone I of the reactor at an adiabatic combustion temperature of about 1300° C. and a residence time of about 40 msec.

Subsequently, 6500 m³ (STP)/h of forming gas (80:20% by vol. of N2/H2) are added to the reaction mixture leaving zone I in a zone II. This cools the entire reaction mixture to 250° C.

In the zone III downstream of the zone II, the solid is deposited out of the gaseous substances on a filter, and 10 m³ (STP)/h of air are added to the offgas stream.

The physicochemical values of the resulting solid are reproduced in Table 1.

### Example 2

As Example 1, but with different feedstock amounts for SiCl₄ and FeCl₂.

### Example 3

As Example 1, except using a solution of 97 parts of iron(II) chloride and 3 parts of iron(III) chloride instead of a solution of iron(II) chloride.

### Example 4

As Example 1, except using a solution of iron(III) chloride instead of a solution of iron(II) chloride. Furthermore, an additional 6.0 m³ (STP)/h of steam are introduced into zone II.

### Example 5-7

As Example 1, except using a solution of 25% by weight of iron(II) chloride and 20% by weight of manganese(II) chloride.

### Example 8

0.28 kg/h of SiCl₄ is evaporated and fed into a mixing zone with 7.0 m³ (STP)/h of hydrogen and 16 m³ (STP)/h of air.

In addition, an aerosol which is obtained from a 25 per cent by weight solution of iron(II) chloride in water by means of a two-substance nozzle is introduced into the mixing zone within the burner by means of a carrier gas (4.0 m³ (STP)/h of nitrogen). The homogeneously mixed gas-aerosol mixture burns in zone I of the reactor at an adiabatic combustion temperature of about 1230° C. and a residence time of about 50 msec.

Subsequently, 12 kg/h of quench air are added to the reaction mixture leaving zone I in a zone II. This cools the entire reaction mixture to 280° C.

In the zone III downstream of zone II, the solid is deposited out of the gaseous substances on a filter. In the course of deposition, an oxidizing atmosphere is present.

### Example 9

As Example 8, except using a solution of 25% by weight of iron(II) chloride and 20% by weight of manganese(II) chloride. Furthermore, an additional 8 kg/h of steam are introduced into zone II.

In the zone III downstream of zone II, the solid is deposited out of the gaseous substances on a filter. In the course of deposition, a reducing atmosphere is present.

Feedstocks, use amounts and reaction parameters of Examples 1 to 9 are reproduced in Table 1. The physico-chemical values of the resulting solids are reproduced in Table 2.

TABLE 1
Reaction parameters of inventive Examples 1 to 9

| | | Example | | | | | | | | |
|---|---|---|---|---|---|---|---|---|---|---|
| | | 1 | 2 | 3 | 4 | 5 | 6 | 7 | 8 | 9 |
| SiCl₄ | kg/h | 0.87 | 2.54 | 1.56 | 1.56 | 1.56 | 0.28 | 1.747 | 0.34 | 0.34 |
| Hydrogen | m³ | 7.00 | 6.60 | 6.60 | 6.60 | 6.60 | 6.60 | 6.60 | 7.00 | 8.00 |
| | (STP)/h | | | | | | | | | |
| Air | m³ | 18.00 | 17.50 | 18.50 | 18.50 | 18.50 | 17.50 | 18.50 | 15.0 | 15 |
| | (STP)/h | | | | | | | | | |
| FeCl₂ | kg/h | 4.60 | 2.46 | 0 | 0 | 4.50 | 4.50 | 4.122 | 4.45 | 4.360 |
| FeCl₃ | kg/h | 0 | 0 | 4.5 | 4.5 | 0 | 0 | 0 | 0 | 0 |
| MnCl₂ | kg/h | 0 | 0 | 0 | 0 | 0.060 | 0.090 | 0.128 | 0 | 0.087 |
| Carrier gas | m³ | 3 | 5 | 4 | 4 | 4 | 4 | 4 | 3 | 3 |
| | (STP)/h | | | | | | | | | |
| Adiabatic | ° C. | 1300 | 1150 | 1200 | 1200 | 1200 | 1250 | 1200 | 1280 | 1210 |
| temp. | | | | | | | | | | |
| Residence | ms | 40 | 50 | 50 | 50 | 50 | 50 | 50 | 50 | 50 |
| time | | | | | | | | | | |
| Forming gas* | m³ | 6500 | 4500 | 6000 | 6000 | 6000 | 4000 | 6000 | 0 | 0 |
| | (STP)/h | | | | | | | | | |
| Quench air | m³ | 0 | 0 | 0 | 0 | 0 | 0 | 0 | 12 | 3 |
| | (STP)/h | | | | | | | | | |
| Steam | kg/h | 6.0 | 7.0 | 4.0 | 0 | 0 | 5.0 | 0 | 0 | 8.0 |
| Temperature** | ° C. | 250 | 225 | 400 | 380 | 390 | 300 | 390 | 280 | 260 |
| Deposition*** | | red. | red. | red. | red. | red. | red. | red. | ox. | red. |

*4:1 parts by volume of H₂/N₂;
**after cooling;
***red.(ox.) = deposition of the powder in reducing (oxidizing) atmosphere

TABLE 2
Physicochemical values of the powders from Examples 1 to 9

| | | Example | | | | | | | | |
|---|---|---|---|---|---|---|---|---|---|---|
| | | 1 | 2 | 3 | 4 | 5 | 6 | 7 | 8 | 9 |
| BET surface | m²/g | 30 | 70 | 50 | 53 | 48 | 50 | 52 | 60 | 56 |
| area | | | | | | | | | | |
| Ø Iron oxide^{a)} | nm | 10-40 | 10-20 | 10-30 | 10-30 | 10-30 | 10-30 | 10-30 | 10-25 | 10-25 |
| Silicon | % by wt. | 29 | 69 | 48 | 48 | 48.5 | 14.6 | 48.5 | 14 | 13 |
| dioxide | | | | | | | | | | |
| Iron oxide | % by wt. | 68.5 | 28 | 49 | 49 | 49 | 82 | 48 | 83 | 83 |
| Maghemite | % | 26 | 20 | 20 | 51 | 20 | 22 | 21 | 63 | 65 |
| Magnetite | % | 61 | 75 | 65 | 22 | 70 | 69 | 71 | 30 | 30 |
| Haematite | % | 9 | 5 | 10 | 17 | 7 | 9 | 8 | 5 | 5 |
| beta-Fe₂O₃ | % | 4 | 0 | 5 | 10 | 3 | 0 | 0 | 2 | 0 |
| Chloride | % by wt. | 1.5 | 1.9 | 2.0 | 3.0 | 1.93 | 1.54 | 1.5 | 2.0 | 2.0 |
| Manganese | % by | 0.6 | 0.1 | 0.8 | 0.6 | 0.67 | 1.8 | 2.0 | 0.4 | 2.0 |
| oxide | wt.^{c)} | | | | | | | | | |
| Saturation | Am²/kg | 51.3 | 20.7 | 43.6 | 28.6 | 44.9 | 56.8 | 48.6 | 58.5 | 57.0 |
| magnetization | | | | | | | | | | |
| Saturation | Am²/kg | 74.9 | 73.9 | 89.0 | 58.4 | 91.6 | 69.3 | 101.3 | 92.9 | 68.7 |
| magnetization/ | Fe₂O₃ | | | | | | | | | |
| Fe₂O₃ | | | | | | | | | | |
| Curie | ° C. | 613 | 596 | 610 | 601 | 640 | 630 | 613 | 605 | 613 |
| temperature | | | | | | | | | | |

^{a)}Ø = mean particle diameter of iron oxide;
^{b)}as Fe₂O₃;
^{c)}as MnO₂.

### Comparative Example 1 (C-1)

0.14 kg/h of SiCl₄ is evaporated at approx. 200° C. and fed into a mixing zone with 3.5 m³ (STP)/h of hydrogen and 15 m³ (STP)/h of air. In addition, an aerosol which is obtained from a 10% by weight aqueous iron(III) chloride solution, corresponding to 1.02 kg/h of iron(II) chloride, by means of a two-substance nozzle, is introduced into the mixing zone within the burner by means of a carrier gas (3 m³ (STP)/h of nitrogen).

The homogeneously mixed gas-aerosol mixture burns there at an adiabatic combustion temperature of about 1200° C. and a residence time of about 50 msec.

After the flame hydrolysis, the reaction gases and the powder formed are cooled, and the solid is separated from the offgas stream by means of a filter. In a further step, treatment with steam-containing nitrogen removes hydrochloric acid residues which still adhere on the powder.

The powder has an iron oxide content of 50% by weight, a BET surface area of 146 m²/g, a chloride content of 368 ppm and a saturation magnetization of 17 Am²/kg.

### Comparative Example 2 (C-2)

As C-1, except using 0.23 kg/h of SiCl₄ and 0.41 kg/h of FeCl₃. The powder has an iron oxide content of 50% by weight, a BET surface area of 174 m²/g, a chloride content of 220 ppm and a saturation magnetization of 6.5 Am²/kg.

### Comparative Example 3 (C-3)

As C-1, except using 0.21 kg/h of SiCl₄ and 0.40 kg/h of FeCl₂.

The powder has an iron oxide content of 25% by weight, a BET surface area of 143 m²/g, a chloride content of 102 ppm and a saturation magnetization of 10.4 Am²/kg.

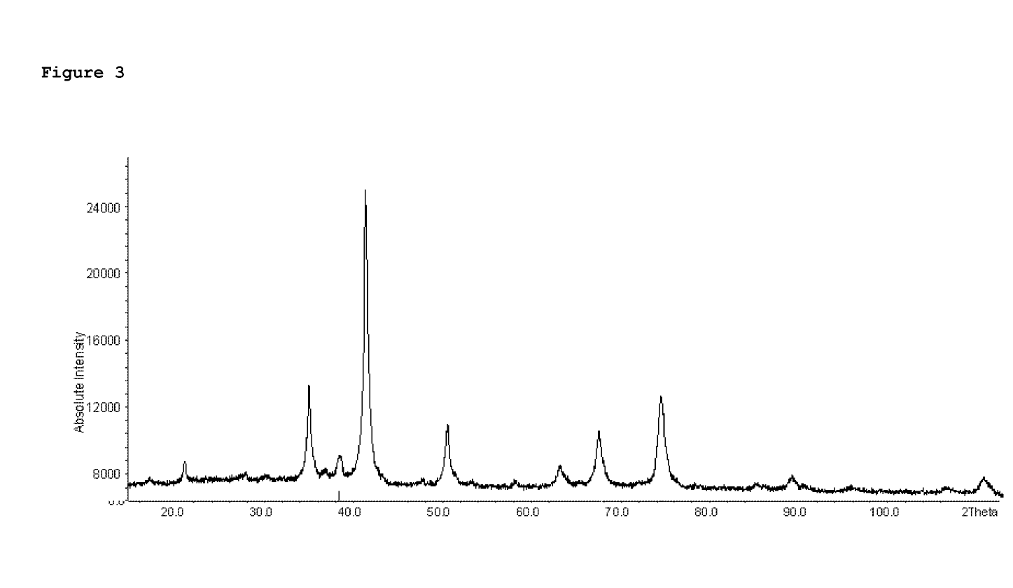

X-ray diffractograms (XRD): Haematite is identifiable unambiguously owing to the unobscured reflections. The reflections of magnetite and of maghemite overlap one another to a very high degree. Maghemite is detectable significantly on the basis of the (110) and (211) reflections in the acute angle range. With the aid of the Rietveld method, quantitative phase analysis is performed (error approx. 10% relative). FIG. 3 shows the X-ray diffractogram of the powder from Example 5.

The reactant used is a silicon-iron mixed oxide according to EP1284485. It has the physicochemical characteristics listed in Table 3.

The reactant is initially charged in a mixer and, while mixing intensively, sprayed optionally first with water and then with the surface modifier.

Once the spraying has ended, it is possible to continue mixing for another 15 to 30 minutes and then to heat treat at 50 to 400° C. for 1 to 6 h.

The water used may be acidified with an acid, for example hydrochloric acid, down to a pH of 7 to 1. The silanizing agent used may be dissolved in a solvent, for example ethanol.

The further details are listed in Tables 4 to 7.

TABLE 3

| | | Result for | Result for |
|---|---|---|---|
| | Unit | Ex. 1 to 4 | Ex. 5 to 7 |
| BET surface area | m²/g | 40 | 48 |
| Fe oxide mean diameter | nm | 10-30 | 10-30 |
| Fe₂O₃ content, RFA | % | 81 | 80 |
| SiO₂ content, RFA | % | 13 | 14 |
| SiO₂ shell from TEM | nm | 1-5 | 1-3 |
| Chlorine content | % | 2.63 | 1.44 |
| MnO content, RFA | % | 1.0 | 1.6 |
| Magnetite Fe₃O₄ | % | 61 | 63 |
| Magnetite Fe₂O₃ | % | 26 | 22 |
| Fe₃O₄/Fe₂O₃ ratio | | 1:2.3 | 1:2.8 |
| Haematite | % | 9 | 10 |
| β-Fe₂O₃ | % | 4 | 5 |
| Crystal size from magnetite | nm | 36 | 26 |
| (picks) | | | |
| Saturation magnetization | % | 51.3 | 44.9 |

TABLE 4
Preparation of the surface-modified oxides

| | | | | Heat | |
|---|---|---|---|---|---|
| | | Parts of | Parts of | treatment | Heat |
| | | SM*/100 | H2O/100 | temperature | treatment |
| Example | Surface modifier | parts of oxide | parts of oxide | [° C.] | time [h] |
| 1 | Octyltrimethoxy- | 10 | — | 150 | 2 |
| | silane | | | | |
| 2 | Propyltrimethoxy- | 5 | 0.5 | 120 | 2 |
| | silane | | | | |
| 3 | Trimethoxysilyl- | 15 | — | 120 | 2 |
| | propyl methacrylate | | | | |
| 4 | Hexamethyldisilazane | 10 | 0.5 | 150 | 1 |
| 5 | Octyltrimethoxy- | 10 | — | 120 | 2 |
| | silane | | | | |
| 6 | Octyltrimethoxy- | 10 | 0.5 | 160 | 3 |
| | silane | | | | |
| 7 | Trimethoxysilyl- | 5 | — | 120 | 2 |
| | propyl methacrylate | | | | |

*SM = Surface modifier

TABLE 5
Overview of hydrophobizing agents

| Properties | Hexamethyldisilazane | n-Propyltrimethoxysilane | Octyltrimethoxysilane | 3-Trimethoxysilylpropyl methacrylate |
|---|---|---|---|---|
| pH | — | — | | — |
| Melting point | -80 | — | — | — |
| in °C. | | | | |
| Boiling point | 126 | 137 | 246 | 255 |
| in °C. | | | | |
| (DIN51751) | | | | |
| Flashpoint | 11 | 35 | 102 | 110 |
| in °C. | | | | |
| (DIN 51751) | | | | |
| Ignition | 380 | 245 | — | — |
| temperature | | | | |
| in °C. | | | | |
| (DIN 51794) | | | | |
| Vapour pressure | 12 | 93 | 3 | — |
| in hPa (at 20° C.) | | | | |
| Density in g/cm³ | 0.77 | 0.94 | 0.91 | 1.04 |
| (DIN51757) | | | | |
| Water solubility | immiscible | hydrolysis | hydrolysis | hydrolysis |
| Viscosity in | — | 0.7 | 2 | 2.8 |
| mPas (DIN53015 | | | | |
| at 20° C.) | | | | |
| CAS No. | 99-97-3 | 1067-25-0 | 67-56-1 | 2530-85-0 |
| EG No. | 213-668-5 | 213-926-7 | 200-659-6 | 219-785-8 |
| Empirical formula | C6H19NSi2 | C6H16O3Si | C11H26O3Si | C1OH20O5Si |
| Molar mass | 161.3964 | 164.2765 | 234.4112 | 248.2696 |
| in g/mol | | | | |
| Structural formula | 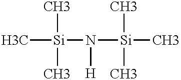 | 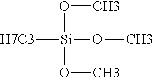 | 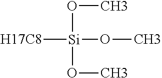 | 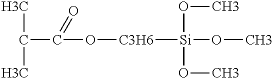 |
| | HMDS | PTMO | OCTMO | MEMO |

TABLE 6
Physicochemical data of the surface-modified oxides
Hydrophobized MagSilica

| | | Reference, | | | | | | | |
|---|---|---|---|---|---|---|---|---|---|
| | | hydrophilic | | | | | | | |
| | | EP | Ex. 1 | Ex. 2 | Ex. 3 | Ex. 4 | Ex. 5 | Ex. 6 | Ex. 7 |
| | | 071097863.8 | OCTMO | PTMO | MEMO | HMDS | OCTMO | OCTMO | MEMO |
| Surface area | m²/g | 40-120 | 28 | 33 | 33 | 40 | 46 | 34 | 41 |
| Iron oxide | % | 50-85 | 77.76 | 78.49 | 78.65 | 80.60 | 75.20 | 75.60 | 77.68 |
| SiO₂ | % | 15-50 | 12.48 | 12.60 | 12.62 | 12.94 | 13.16 | 13.23 | 13.59 |
| Maghemite | % | 20-65 | 10 | 71 | 15 | 14 | 51 | 31 | 12 |
| Magnetite | % | 30-75 | 71 | 73 | 69 | 70 | 38 | 56 | 80 |
| Haematite | % | 5-17 | 19 | 16 | 16 | 16 | 11 | 13 | 8 |
| Crystal particle size from | nm | | 36 | 32 | 33 | 29 | 27 | 33 | 29 |
| magnetite | | | | | | | | | |
| Saturation magnetization | Am²/kg | 20.7-58.5 | 43.6 | 44.9 | 56.8 | 48.6 | 58.5 | 57.0 | 42.3 |
| Saturation magnetization/Fe₂O₃ | Am²/kg Fe₂O₃ | 58.4-101.3 | 89.0 | 91.6 | 69.3 | 101.3 | 92.9 | 68.7 | 81.6 |
| Carbon content | % | <0.4 | 4 | 3.1 | 2.9 | 0.5 | 6 | 5.5 | 2.9 |
| DVS isotherm | 20% | 0.36 | 0.07 | | | | | | |
| | 40% | 0.54 | 0.21 | | | | | | |
| | 60% | 2.24 | 1.48 | | | | | | |
| DL | % | >0.5 | 0.2 | 0.2 | 0.1 | 1 | 0.4 | 0.4 | 0.1 |
| IL | % | >5 | 4.5 | 3.7 | 4.9 | 1 | 7.2 | 5.9 | 4.8 |
| Tamped density | g/l | <150 | 191 | 276 | 237 | 289 | 191 | 304 | |
| Curie temp. | ° C. | 595-613 | | | | | | | |
| Heating rate A | ° C./s | 46-50 | 225 | 162 | 185 | 205 | 170 | 167 | 208 |
| Heating rate B | ° C./s | 24-30 | 73 | 67 | 76 | 66 | 66 | 62 | 70 |

TABLE 7
Particle count from TEM, Example 1

| | |
|---|---|
| Total number of particles measured N: | 2113 |
| Particle diameter, arithmetic mean DN: | 15.579 nm |
| Particle diameter, averaged over the surface area DA: | 35.673 nm |
| Particle diameter, averaged over the volume DV: | 53.942 nm |
| Particle diameter, standard deviation S: | 10.238 nm |
| Particle diameter, coefficient of variation V: | 65.714 |
| Specific surface area OEM: | 58.085 m²/g |
| Median of numerical distribution D50 (A): | 12.425 nm |
| Median of weight distribution D50 (g): | 51.112 nm |
| 90% range, numerical distribution: | 6.004-30.900 nm |
| 90% range, weight distribution: | 13.096-101.854 nm |
| Overall range: | 4.340-109.220 nm |

The inventive surface-modified superparamagnetic particles exhibit good incorporation into alcohol, which extends the spectrum of use in adhesives.

In addition, the tendency to absorb water is significantly reduced (see Table 4, DVS isotherm), as a result of which the inventive product is significantly more stable and possesses a higher heating capacity.

This is because a greater tendency to absorb water would reduce the heating capacity.

Owing to the higher heating capacity, the inventive product can be used in inductive adhesive systems in the low-frequency tension range (see Table 4, heating rates A and B).

1. Hydrophobized silicon-iron mixed oxide powder, characterized in that it has the following physicochemical characteristics:

| | |
|---|---|
| BET surface area | 20 to 75 m²/g |
| Carbon content | 0.5 to 10% by weight |
| Tamped density | 150 to 600 g/l |
| Chlorine content | 0.1 to 3.0% |
| Drying loss | 0.1 to 4% by weight |
| DVS isotherm (60%) | 0.5 to 1.5% by weight |
| Heating rate (1s, 10%) | 50 to 550° C./s |
| 90% range (number) | 5 to 50 nm |
| 90% range (weight) | 5 to 150 nm |
| Overall range | 2 to 200 nm. |

2. Process for preparing the hydrophobized silicon-iron mixed oxide powder according to claim 1, characterized in that a silicon-iron mixed oxide powder is optionally sprayed first with water and then with a surface modifier at room temperature, optionally mixed for a further 15 to 30 minutes and then heat treated at 50 to 400° C. over 1 to 6 hours.

3. Process for preparing the hydrophobized silicon-iron mixed oxide powder according to claim 1, characterized in that a silicon-iron mixed oxide powder is treated with the surface modifier in vapour form and the mixture is then treated thermally at a temperature of 50 to 800° C. over a period of 0.5 to 6 h.

4. Use of the hydrophobized silicon-iron mixed oxide powder according to claim 1 as a filler in adhesives.
